(19) United States
(12) Patent Application Publication
(10) Pub. No.: US 2022/0309351 A1
(43) Pub. Date: Sep. 29, 2022

(54) STRUCTURE TRANSFORMATION DEVICE, STRUCTURE TRANSFORMATION METHOD, AND COMPUTER READABLE MEDIUM

(71) Applicant: MITSUBISHI ELECTRIC CORPORATION, Tokyo (JP)

(72) Inventors: Shunsuke TATSUMI, Tokyo (JP); Ryo YAMAMOTO, Tokyo (JP); Hidetomo IWAGAWA, Tokyo (JP)

(73) Assignee: MITSUBISHI ELECTRIC CORPORATION, Tokyo (JP)

(21) Appl. No.: 17/839,947

(22) Filed: Jun. 14, 2022

Related U.S. Application Data
(63) Continuation of application No. PCT/JP2020/004151, filed on Feb. 4, 2020.

(51) Int. Cl. G06N 3/08; G06N 3/04

(52) U.S. Cl. CPC G06N 3/082; G06N 3/04

(57) ABSTRACT

A processing time calculation unit (221) calculates, based on performance information (32) on a computing unit in which a neural network is implemented, processing time to be taken for processing by the neural network in case where the neural network is implemented in the computing unit. An attainment determination unit (23) determines whether the calculated processing time is longer than required time or not. A structure transformation unit (225) transforms a structure of the neural network in case where it is determined that the processing time is longer than the required time and refrains from transforming the structure of the neural network in case where it is determined that the processing time is equal to or shorter than the required time.

### CROSS REFERENCE TO RELATED APPLICATIONS

This application is a Continuation of PCT International Application No. PCT/JP2020/004151 filed on Feb. 4, 2020, which is hereby expressly incorporated by reference into the present application.

### TECHNICAL FIELD

The present disclosure relates to a technique at transforming a structure of a neural network.

### BACKGROUND ART

Transformation of structures of neural networks is carried out in order to increase processing speeds of the neural networks.

Patent Literature 1 discloses determination of a column dimension reduction amount in total of all layers for parameters based on a processing speed increasing target and determination of a column dimension reduction amount of each layer such that the closer to an input layer the layer is, the smaller the reduction amount for the layer is. Meanwhile, Patent Literature 2 discloses relearning with random reduction in number of network parameters and transformation into a network, subjected to the reduction, at time when a cost determined from recognition accuracy is improved compared with before the reduction.

### CITATION LIST

### Patent Literature

Patent Literature 1: JP 2018-109947
Patent Literature 2: JP 2015-11510

### SUMMARY OF INVENTION

### Technical Problem

In the techniques disclosed in Patent Literature 1 and Patent Literature 2, the number of the parameters is reduced without consideration of performance of a computing unit in which the neural network is implemented. Accordingly, when the neural network after the transformation is implemented in a computing unit, performance requirements may not be attained. Meanwhile, the number of the parameters may be reduced though the performance requirements have been attained, so that the recognition accuracy may be lowered excessively.

The present disclosure mainly aims at enabling attainment of the performance requirements without undue reduction in the recognition accuracy in a neural network.

### Solution to Problem

A structure transformation device according to the present disclosure includes a processing time calculation unit to calculate, based on performance information on a computing unit in which a neural network is implemented, processing time to be taken for processing by the neural network in case where the neural network is implemented in the computing unit;

an attainment determination unit to determine whether the processing time calculated by the processing time calculation unit is longer than required time or not; and

a structure transformation unit to transform a structure of the neural network in case where the attainment determination unit determines that the processing time is longer than the required time and to refrain from transforming the structure of the neural network in case where the attainment determination unit determines that the processing time is equal to or shorter than the required time.

### Advantageous Effects of Invention

In the present disclosure, the processing time, to be taken in case where the neural network is implemented in the computing unit, is calculated and the structure of the neural network is transformed in case where the processing time is longer than the required time. Thus, undue transformation of the structure of the neural network is prevented. As a result, the attainment of the performance requirements is enabled without undue reduction in the recognition accuracy in the neural network.

### BRIEF DESCRIPTION OF DRAWINGS

FIG. 1 is a hardware configuration diagram of a structure transformation device 10 according to Embodiment 1.

FIG. 2 is a functional configuration diagram of the structure transformation device 10 according to Embodiment 1.

FIG. 3 is a flowchart illustrating general operation of the structure transformation device 10 according to Embodiment 1.

FIG. 4 is a flowchart illustrating a process of calculating an evaluated value according to Embodiment 1.

### DESCRIPTION OF EMBODIMENTS

### Embodiment 1

*** Description of Configuration ***

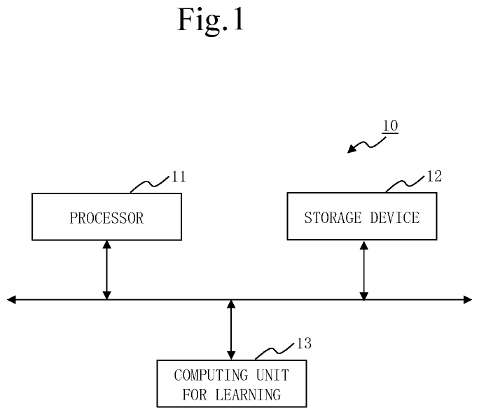

With reference to FIG. 1, an example of a hardware configuration of a structure transformation device 10 according to Embodiment 1 will be described.

The structure transformation device 10 is a computer to transform a structure of a neural network.

The structure transformation device 10 includes a processor 11, a storage device 12, and a computing unit 13 for learning, as hardware. The processor 11 is connected to other hardware through signal lines so as to control the other hardware.

The processor 11 is an IC (Integrated Circuit) to carry out processing. A specific example of the processor 11 is CPU (Central Processing Unit).

The storage device 12 is a device to store data. Specific examples of the storage device 12 are RAM (Random Access Memory), ROM (Read Only Memory), and HDD (Hard Disk Drive).

Meanwhile, the storage device 12 may be a portable recording medium such as SD (registered trademark, Secure Digital) memory card, CF (CompactFlash, registered trademark), NAND flash, flexible disk, optical disk, compact disk, Blu-ray (registered trademark) disk, or DVD (Digital Versatile Disk).

The computing unit 13 for learning is an IC to execute a learning process by a neural network at high speed. A specific example of the computing unit 13 for learning is GPU (Graphics Processing Unit).

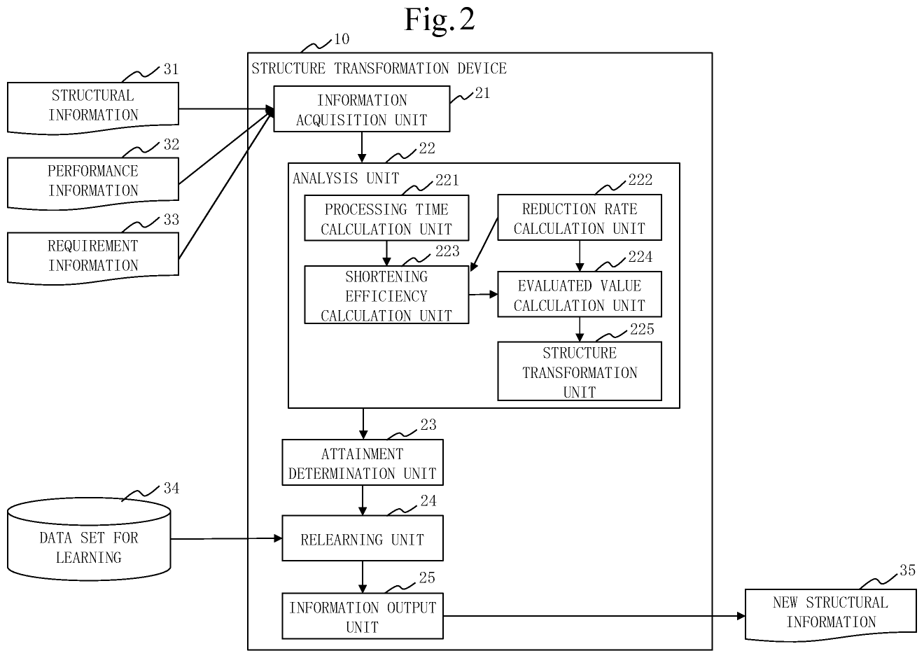

With reference to FIG. 2, a functional configuration of the structure transformation device 10 according to Embodiment 1 will be described.

The structure transformation device 10 includes an information acquisition unit 21, an analysis unit 22, an attainment determination unit 23, a relearning unit 24, and an information output unit 25, as functional components. The analysis unit 22 includes a processing time calculation unit 221, a reduction rate calculation unit 222, a shortening efficiency calculation unit 223, an evaluated value calculation unit 224, and a structure transformation unit 225. Functions of the functional components of the structure transformation device 10 are implemented by software.

In the storage device 12, programs that fulfill the functions of the functional components of the structure transformation device 10 are stored. The programs that fulfill the information acquisition unit 21, the analysis unit 22, the attainment determination unit 23, and the information output unit 25 are read into and executed by the processor 11. Meanwhile, the program that fulfills the relearning unit 24 is read into and executed by the computing unit 13 for learning. Thus, the functions of the functional components of the structure transformation device 10 are implemented.

The structure transformation device 10 uses structural information 31, performance information 32, requirement information 33, and a data set 34 for learning, as input, and outputs new structural information 35 transformed from the structural information 31.

*** Description of Operation ***

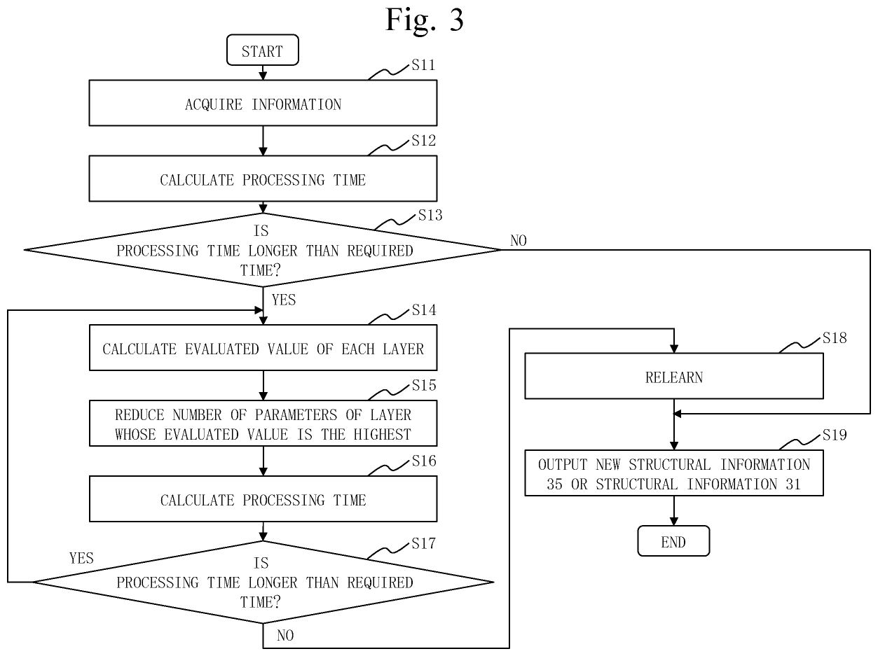

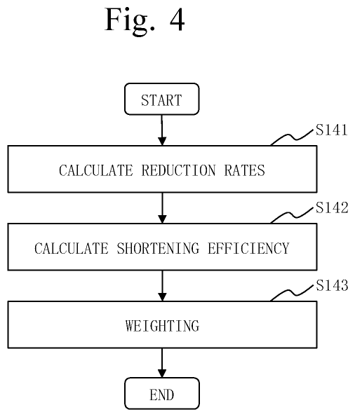

With reference to FIGS. 3 and 4, operation of the structure transformation device 10 according to Embodiment 1 will be described.

An operation procedure of the structure transformation device 10 according to Embodiment 1 is equivalent to a structure transformation method according to Embodiment 1. Meanwhile, a program that fulfills the operation of the structure transformation device 10 according to Embodiment 1 is equivalent to a structure transformation program according to Embodiment 1.

With reference to FIG. 3, general operation of the structure transformation device 10 according to Embodiment 1 will be described.

The structure transformation device 10 transforms a structure of a neural network to generate a new neural network by executing processes illustrated in FIG. 3.

(Step S11: Information Acquisition Process)

The information acquisition unit 21 acquires the structural information 31, the performance information 32, and the requirement information 33.

Specifically, the structural information 31, the performance information 32, and the requirement information 33 that have been set by, for example, a user of the structure transformation device 10 are read from the storage device 12.

The structural information 31 is information required for determination of a portion of the neural network that is to be transformed. The structural information 31 is information specifying a structure of the neural network. Specifically, the structural information 31 is information required for clarification of contents of an inference process, such as type of layer, weight information, neuron, feature map, and filter size in each of a plurality of layers configuring the neural network. The type of layer is fully connected layer, convolution layer, or the like.

The performance information 32 and the requirement information 33 configure information required for determining whether the performance requirements can be attained when the neural network is implemented in the computing unit. The performance information 32 is information required for estimation of processing time, such as computational performance and bus band of the computing unit in which the neural network is implemented (hereinafter, referred to as implementation destination computing unit). The requirement information 33 is information specifying the processing time that needs to be satisfied when the neural network is executed. The processing time specified by the requirement information 33 is referred to as required time.

(Step S12: First Processing Time Calculation Process)

The processing time calculation unit 221 of the analysis unit 22 refers to the structural information 31 and the performance information 32 and calculates processing time to be taken for a recognition process by the neural network in case where the neural network is implemented in the implementation destination computing unit.

Details of a method of calculating the processing time will be described later.

(Step S13: First Attainment Determination Process)

The attainment determination unit 23 determines whether performance of the neural network satisfies the requirement or not. Specifically, the attainment determination unit 23 determines whether the processing time calculated in step S12 is longer than the required time specified by the requirement information 33 or not.

In case where the processing time is longer than the required time, the attainment determination unit 23 advances processing to step S14. On the other hand, in case where the processing time is equal to or shorter than the required time, the attainment determination unit 23 advances the processing to step S19.

(Step S14: Evaluated Value Calculation Process)

The evaluated value calculation unit 224 of the analysis unit 22 sets each of a plurality of layers configuring the neural network as an object layer and calculates an evaluated value representing reduction priority for a parameter of the object layer. The parameter is a feature determining a structure of a portion of the neural network corresponding to one layer. As a specific example, the parameter for the fully connected layer is neuron and the parameter for the convolution layer is channel.

Details of a method of calculating the evaluated value will be described later.

(Step S15: Structure Transformation Process)

The structure transformation unit 225 of the analysis unit 22 identifies a layer whose evaluated value calculated in step S14 is the highest, as a reduction layer. That is, the structure transformation unit 225 identifies the layer having the highest reduction priority, as the reduction layer.

Then, the structure transformation unit 225 makes a reduction by a reduction number of parameters in the reduction layer. The reduction number is an integer that is equal to or greater than 1. In Embodiment 1, the reduction number is set at 1. The structure transformation unit 225 transforms the structure of the neural network to generate a new neural network by reducing the number of the parameters. Incidentally, it is sufficient if the parameters to be subjected to the reduction are selected with use of an existing technique.

(Step S16: Second Processing Time Calculation Process)

The processing time calculation unit 221 of the analysis unit 22 refers to the structural information 31 and the performance information 32 and calculates processing time to be taken for a recognition process by the new neural network generated in step S15 in case where the new neural network is implemented in the implementation destination computing unit.

Details of the method of calculating the processing time will be described later.

(Step S17: Second Attainment Determination Process)

The attainment determination unit 23 determines whether performance of the new neural network satisfies the requirement or not. Specifically, the attainment determination unit 23 determines whether the processing time calculated in step S16 is longer than the required time specified by the requirement information 33 or not.

In case where the processing time is longer than the required time, the attainment determination unit 23 returns the processing to step S14. On the other hand, in case where the processing time is equal to or shorter than the required time, the attainment determination unit 23 advances the processing to step S18.

When the processing is returned to step S14, the evaluated values of layers configuring the new neural network generated by the process of the last step S15 are calculated in step S14. In step S15, subsequently, a newer neural network is generated.

That is, by iterated execution of the processes of steps S14 to S18, the structure of the neural network is gradually changed until the performance of the neural network satisfies the requirement. In other words, the structure of the neural network is gradually changed until the processing time of the neural network is made equal to or shorter than the required time.

(Step S18: Relearning Process)

The relearning unit 24 uses the data set 34 for learning as input and carries out relearning for the new neural network generated by the process of the last step S15. Thus, recognition accuracy for the new neural network is increased.

Then, the relearning unit 24 generates new structural information 35 specifying a structure of the neural network subjected to the relearning. As with the structural information 31, the new structural information 35 is information required for the clarification of the contents of the inference process, such as type of layer, weight information, neuron, feature map, and filter size in each of the plurality of layers configuring the neural network.

(Step S19: Output Process)

In case where it is determined in step S13 that the processing time is longer than the required time, the information output unit 25 outputs the new structural information 35 generated in step S18. On the other hand, in case where it is determined in step S13 that the processing time is equal to or shorter than the required time, the information output unit 25 outputs the structural information 31 acquired in step S11.

The method of calculating the processing time in step S12 and step S16 will be described.

The processing time calculation unit 221 calculates processing time for the entire neural network by totaling the processing time to be taken by processing for every layer configuring the neural network, as expressed by expression 1.

Processing time=Σ(processing time for one layer) (EXPRESSION 1)

The processing time calculation unit 221 sets each of the plurality of layers configuring the neural network as an object layer and calculates processing time for the object layer by dividing a computation amount for the object layer by computational performance of the implementation destination computing unit, as expressed by expression 2.

Processing time for one layer=(computation amount for one layer)/(computational performance of implementation destination computing unit) (EXPRESSION 2)

The computation amount for the object layer is identified from the structure of the neural network specified by the structural information 31. The computational performance of the implementation destination computing unit is information specified by the performance information 32 and is identified from specifications or an actual measured value for the implementation destination computing unit.

Incidentally, the method of calculating the processing time is not limited to the method described herein. For instance, the processing time calculation unit 221 may calculate the processing time by doing a simulation.

With reference to FIG. 4, the method of calculating the evaluated value in step S14 will be described.

(Step S141: Reduction Rate Calculation Process)

The reduction rate calculation unit 222 calculates an initial parameter reduction rate and a current parameter reduction rate for the object layer. The initial parameter reduction rate is a ratio of the reduction number y of the parameters to the number of the parameters in the object layer of an initial neural network. The current parameter reduction rate is a ratio of the reduction number y of the parameters to the number of the parameters in the object layer of a current neural network. The initial neural network refers to the neural network specified by the structural information 31 acquired in step S11. In case where a new neural network has already been generated in step S15, the current neural network refers to the latest neural network generated in step S15. In case where a new neural network has not been generated yet in step S15, the current neural network is the same as the initial neural network.

Specifically, the reduction rate calculation unit 222 calculates the initial parameter reduction rate Δαₓ₁ and the current parameter reduction rate Δαₓ₂ for the object layer Lₓ, by using expression 3. Herein, y is the reduction number. Nₓ is the number of parameters in the layer Lₓ of the initial neural network. nₓ is the number of parameters in the layer Lₓ of the current neural network.

Δαₓ₁=1−(nₓ−y)/Nₓ

Δαₓ₂=1−(nₓ−y)/nₓ=y/nₓ (EXPRESSION 3)

In Embodiment 1, as described above, the reduction number y is 1. In Embodiment 1, therefore, the reduction rate calculation unit 222 calculates the initial parameter reduction rate Δαₓ₁ and the current parameter reduction rate Δαₓ₂ for the object layer Lₓ, by using expression 4.

Δαₓ₁=1−(nₓ−1)/Nₓ

Δαₓ₂=1−(nₓ−1)/nₓ=1/nₓ (EXPRESSION 4)

(Step S142: Shortening Efficiency Calculation Process)

The shortening efficiency calculation unit 223 calculates shortening efficiency for the object layer. The shortening efficiency is a ratio of a shortening amount in the processing time, to be taken in case where a reduction by the reduction number y of parameters is made, to the current parameter reduction rate Δαₓ₂.

Specifically, the shortening efficiency calculation unit 223 calculates the shortening efficiency Δpₓ for the object layer Lₓ, by using expression 5. Herein, d_{y} is the shortening amount in the processing time in case where the reduction of the parameters numbering in y is made.

Δpₓ=d_{y}/(y/nₓ) (EXPRESSION 5)

In Embodiment 1, as described above, the reduction number y is 1. In Embodiment 1, therefore, the shortening efficiency calculation unit 223 calculates the shortening efficiency Δpₓ for the object layer Lₓ, by using expression 6.

Δpₓ=d₁/(1/nₓ) (EXPRESSION 6)

It is thought that the processing time is proportional to the computation amount. Accordingly, a computation efficiency Δp′ₓ that is a decrease in the computation amount, in case where the reduction by the reduction number y of parameters is made, relative to the current parameter reduction rate Δαₓ₂ can be expressed as expression 7. Herein, q is the computational performance of the implementation destination computing unit.

Δp′ₓ=Δpₓ×q (EXPRESSION 7)

Additionally, the computation efficiency Δp′ₓ is the decrease in the computation amount, in case where the reduction by the reduction number y of parameters is made, relative to the current parameter reduction rate Δαₓ₂ and thus can be expressed also as expression 8. Herein, e_{y} is a decrease in the computation amount in case where the reduction of the parameters numbering in y is made.

Δp′ₓ=e_{y}/(1/nₓ) (EXPRESSION 8)

Accordingly, the computation efficiency Δp′ₓ is expressed as expression 9 in case where the reduction number y is 1.

Δp′ₓ=e₁/(1/nₓ) (EXPRESSION 9)

Herein, the computation efficiency Δp′ₓ in case where a reduction of one parameter has been made is calculated by division of sum of a computation reduction amount for the layer Lₓ in case where a reduction of one parameter for the layer Lₓ is made and a computation reduction amount for the layer Lₓ₊₁ in case where a reduction of one parameter for the layer Lₓ is made, by the current parameter reduction rate Δαₓ₂ for the layer Lₓ in case where the reduction of one parameter is made. Accordingly, the computation efficiency Δp′ₓ in case where the reduction of one parameter has been made is calculated by use of expression 10.

Δp′ₓ=(−nₓ₋₁−nₓ₊₁)/(1/nₓ) (EXPRESSION 10)

Accordingly, the shortening efficiency calculation unit 223 is capable of calculating the shortening efficiency Δpₓ for the object layer Lₓ by using expression 11.

Δpₓ=Δp′ₓ/q=((−nₓ₋₁−nₓ₊₁)/(1/nₓ))/q (EXPRESSION 11)

(Step S143: Weighting Process)

The evaluated value calculation unit 224 calculates the evaluated value by multiplying the shortening efficiency Δpₓ, calculated in step S142, by a weight obtained by a weighting function g from the initial parameter reduction rate Δαₓ₁ calculated in step S141. That is, the evaluated value calculation unit 224 calculates the evaluated value sₓ for the object layer Lₓ, by using expression 12.

sₓ=Δpₓ×g(Δαₓ₁) (EXPRESSION 12)

Specifically, the evaluated value calculation unit 224 calculates the weight w from the initial parameter reduction rate Δαₓ₁ by using the weighting function g. A specific example of the weighting function g is a function that returns a value resulting from subtraction of an input value from 1. For instance, the weighting function g is a function specified by expression 13. Herein, z is the input value.

g(z)=(1−z)·q (EXPRESSION 13)

A multiplication by the computational performance q is made in expression 13 in order that the computational performance q is not used in calculation of the evaluated value sₓ that will be described later because the computational performance q, which is a constant, has no influence on magnitude of the evaluated value.

Based on the above, the evaluated value calculation unit 224 calculates the evaluated value sₓ for the object layer Lₓ, by using expression 14.

sₓ=(((−nₓ₋₁−nₓ₊₁)/(1/nₓ))/q)×(1−(1−(nₓ−1)/Nₓ))·q=((−nₓ₋₁−nₓ₊₁)/(1/nₓ))×(1−(1−(nₓ−1)/Nₓ)) (EXPRESSION 14)

*** Effects of Embodiment 1 ***

As described above, the structure transformation device 10 according to Embodiment 1 calculates the processing time, to be taken in case where the neural network is implemented in the implementation destination computing unit, and transforms the structure of the neural network in case where the processing time is longer than the required time. Thus, undue transformation of the structure of the neural network is prevented. As a result, the performance requirements can be attained while deterioration in the recognition accuracy in the neural network is prevented as much as possible.

Meanwhile, the structure transformation device 10 according to Embodiment 1 identifies the layer of which the number of the parameters is to be reduced, with use of the shortening efficiency.

Thus, the reduction number of the parameters that is required for attainment of the performance requirements can be decreased. As a result, the deterioration in the recognition accuracy in the neural network after the transformation of the structure can be decreased. In addition, layers having small numbers of the parameters are prone to lower the shortening efficiency and thus have difficulty in being selected as the layers whose parameters are to be deleted. As a result, intensive deletion of the parameters of a portion of the layers, which leads to the deterioration in the recognition accuracy in the neural network after the transformation of the structure, can be prevented.

Meanwhile, the structure transformation device 10 according to Embodiment 1 identifies the layer of which the number of the parameters is to be reduced, with use of the initial parameter reduction rate.

Thus, layers having small numbers of the parameters have difficulty in being selected as the layers whose parameters are to be deleted. As a result, the intensive deletion of the parameters of a portion of the layers, which leads to the deterioration in the recognition accuracy in the neural network after the transformation of the structure, can be prevented.

According to Patent Literature 1, for instance, a parameter reduction amount is determined without consideration of the structure of the neural network so that the closer to an input layer the layer is, the smaller the reduction amount is. Accordingly, in case where a hidden layer close to an output layer has a small number of parameters, a great number of parameters may be reduced from the layer that originally has the small number of parameters, so that the recognition accuracy may be lowered significantly. In the structure transformation device 10 according to Embodiment 1, however, such a reduction of a great number of parameters from a layer that originally has a small number of parameters is prevented.

*** Other Configurations ***

<Modification 1>

In Embodiment 1, the reduction number is set as 1. This is intended for confirming whether the performance requirements have been attained or not, each time one parameter is deleted. Thus, unnecessary deletion of a great number of parameters is prevented.

Two or more parameters, however, may be deleted at a time. Time to arrival at a configuration that attains the performance requirements can be shortened by such deletion of two or more parameters at a time.

<Modification 2>

In Embodiment 1, the relearning for the neural network having a configuration that has attained the performance requirements is carried out in step S18 of FIG. 3. In case where the configuration of the neural network has been transformed to a great extent due to deletion of a large number of parameters or the like, however, the relearning may be carried out in a mid-stage.

For instance, the relearning may be carried out in case where the configuration of the neural network has been transformed a reference number of times.

<Modification 3>

In Embodiment 1, the functional components are implemented by software. In Modification 3, however, the functional components may be implemented by hardware. As for Modification 3, differences from Embodiment 1 will be described.

A configuration of the structure transformation device 10 according to Modification 3 will be described.

In case where the functional components are implemented by hardware, the structure transformation device 10 includes an electronic circuit in place of the processor 11, the storage device 12, and the computing unit 13 for learning. The electronic circuit is a dedicated circuit to implement the functions of the functional components and the storage device 12.

As the electronic circuit, a single circuit, a composite circuit, a programmed processor, a parallelly programmed processor, a logic IC, a GA (Gate Array), an ASIC (Application Specific Integrated Circuit), or an FPGA (Field-Programmable Gate Array) is assumed.

The functional components may be implemented by one electronic circuit or the functional components may be implemented by being distributed among a plurality of electronic circuits.

<Modification 4>

In Modification 4, some of the functional components may be implemented by hardware and the other functional components may be implemented by software.

The processor 11, the storage device 12, the computing unit 13 for learning, and the electronic circuit are referred to as processing circuits. That is, the functions of the functional components are implemented by the processing circuits.

### REFERENCE SIGNS LIST

10: structure transformation device; 11: processor; 12: storage device; 13: computing unit for learning; 21: information acquisition unit; 22: analysis unit; 221: processing time calculation unit; 222: reduction rate calculation unit; 223: shortening efficiency calculation unit; 224: evaluated value calculation unit; 225: structure transformation unit; 31: structural information; 32: performance information; 33: requirement information; 34: data set for learning; 35: new structural information

1. A structure transformation device comprising:
processing circuitry to:
calculate, based on performance information on a computing unit in which a neural network is implemented, processing time to be taken for processing by the neural network in case where the neural network is implemented in the computing unit,
determine whether the calculated processing time is longer than required time or not,
set each of a plurality of layers configuring the neural network as an object layer and calculate an evaluated value representing reduction priority for parameters of the object layer, and
transform a structure of the neural network to generate a new neural network by reducing the number of parameters of a layer of which the calculated evaluated value is elevated in case where it is determined that the processing time is longer than the required time, and refrain from transforming the structure of the neural network in case where it is determined that the processing time is equal to or shorter than the required time, wherein
the processing circuitry calculates the evaluated value based on at least one of a reduction rate in the number of parameters and a shortening amount in the processing time to be attained in case the number of parameters is reduced for each of an initial neural network and a current neural network before being transformed.

2. The structure transformation device according to claim 1,
wherein the processing circuitry calculates processing time for the new neural network that has been generated,
sets each of a plurality of layers configuring the neural network as an object layer and calculates the evaluated value in case where it is determined that the processing time for the new neural network is longer than the required time, and
reduces the number of the parameters of a layer of which the evaluated value calculated with each of the plurality of layers configuring the neural network set as the object layer is elevated and transforms the structure of the neural network.

3. The structure transformation device according to claim 1,
wherein the processing circuitry calculates the evaluated value from an initial parameter reduction rate that is a ratio of a reduction number of parameters to the number of the parameters in the object layer of the initial neural network.

4. The structure transformation device according to claim 2,
wherein the processing circuitry calculates the evaluated value from an initial parameter reduction rate that is a ratio of a reduction number of parameters to the number of the parameters in the object layer of the initial neural network.

5. The structure transformation device according to claim 1,
wherein the processing circuitry calculates the evaluated value from a shortening amount in the processing time that is to be attained in case where a reduction by a reduction number of the parameters is made.

6. The structure transformation device according to claim 2,
wherein the processing circuitry calculates the evaluated value from a shortening amount in the processing time that is to be attained in case where a reduction by a reduction number of the parameters is made.

7. The structure transformation device according to claim 3,
wherein the processing circuitry calculates the evaluated value from a shortening amount in the processing time that is to be attained in case where a reduction by a reduction number of the parameters is made.

8. The structure transformation device according to claim 4,
wherein the processing circuitry calculates the evaluated value from a shortening amount in the processing time that is to be attained in case where a reduction by a reduction number of the parameters is made.

9. The structure transformation device according to claim 1,
wherein the processing circuitry calculates the evaluated value from a shortening efficiency that is a ratio of a shortening amount in the processing time to a current parameter reduction rate, the current parameter reduction rate being a ratio of a reduction number of parameters to the number of the parameters in the object layer of the current neural network, the shortening amount in the processing time being to be attained in case where a reduction by the reduction number of the parameters is made.

10. The structure transformation device according to claim 2,
wherein the processing circuitry calculates the evaluated value from a shortening efficiency that is a ratio of a shortening amount in the processing time to a current parameter reduction rate, the current parameter reduction rate being a ratio of a reduction number of parameters to the number of the parameters in the object layer of the current neural network, the shortening amount in the processing time being to be attained in case where a reduction by the reduction number of the parameters is made.

11. The structure transformation device according to claim 3,
wherein the processing circuitry calculates the evaluated value from a shortening efficiency that is a ratio of a shortening amount in the processing time to a current parameter reduction rate, the current parameter reduction rate being a ratio of a reduction number of parameters to the number of the parameters in the object layer of the current neural network, the shortening amount in the processing time being to be attained in case where a reduction by the reduction number of the parameters is made.

12. The structure transformation device according to claim 4,
wherein the processing circuitry calculates the evaluated value from a shortening efficiency that is a ratio of a shortening amount in the processing time to a current parameter reduction rate, the current parameter reduction rate being a ratio of a reduction number of parameters to the number of the parameters in the object layer of the current neural network, the shortening amount in the processing time being to be attained in case where a reduction by the reduction number of the parameters is made.

13. The structure transformation device according to claim 9, wherein
the processing circuitry calculates the evaluated value by multiplying the shortening efficiency by a weight obtained from an initial parameter reduction rate that is a ratio of a reduction number of parameters to the number of the parameters in the object layer of the initial neural network.

14. The structure transformation device according to claim 10,
wherein the processing circuitry calculates the evaluated value from a shortening efficiency that is a ratio of a shortening amount in the processing time to a current parameter reduction rate, the current parameter reduction rate being a ratio of a reduction number of parameters to the number of the parameters in the object layer of the current neural network, the shortening amount in the processing time being to be attained in case where a reduction by the reduction number of the parameters is made.

15. The structure transformation device according to claim 11,
wherein the processing circuitry calculates the evaluated value from a shortening efficiency that is a ratio of a shortening amount in the processing time to a current parameter reduction rate, the current parameter reduction rate being a ratio of a reduction number of parameters to the number of the parameters in the object layer of the current neural network, the shortening amount in the processing time being to be attained in case where a reduction by the reduction number of the parameters is made.

16. The structure transformation device according to claim 12,
wherein the processing circuitry calculates the evaluated value from a shortening efficiency that is a ratio of a shortening amount in the processing time to a current parameter reduction rate, the current parameter reduction rate being a ratio of a reduction number of parameters to the number of the parameters in the object layer of the current neural network, the shortening amount in the processing time being to be attained in case where a reduction by the reduction number of the parameters is made.

17. A structure transformation method comprising:
calculating based on performance information on a computing unit in which a neural network is implemented, processing time to be taken for processing by the neural network in case where the neural network is implemented in the computing unit;
determining whether the processing time is longer than required time or not;
setting each of a plurality of layers configuring the neural network as an object layer and calculating an evaluated value representing reduction priority for parameters of the object layer; and
transforming a structure of the neural network to generate a new neural network by reducing the number of parameters of a layer of which the evaluated value calculated by the evaluated value calculation unit is elevated in case where it is determined that the processing time is longer than the required time and refraining from transforming the structure of the neural network in case where it is determined that the processing time is equal to or shorter than the required time, wherein
the evaluated value is calculated based on at least one of a reduction rate in the number of parameters and a shortening amount in the processing time to be attained in case the number of parameters is reduced for each of an initial neural network and a current neural network before being transformed.

18. A non-transitory computer readable medium storing a structure transformation program that causes a computer to function as a structure transformation device to execute:
a processing time calculation process of calculating, based on performance information on a computing unit in which a neural network is implemented, processing time to be taken for processing by the neural network in case where the neural network is implemented in the computing unit;
an attainment determination process of determining whether the processing time calculated in the processing time calculation process is longer than required time or not;
an evaluated value calculation process of setting each of a plurality of layers configuring the neural network as an object layer and calculating an evaluated value representing reduction priority for parameters of the object layer; and
a structure transformation process of transforming a structure of the neural network to generate a new neural network by reducing the number of parameters of a layer of which the calculated evaluated value is elevated in case where it is determined in the attainment determination process that the processing time is longer than the required time and refraining from transforming the structure of the neural network in case where it is determined in the attainment determination process that the processing time is equal to or shorter than the required time, wherein
in the evaluated value calculation process, the evaluated value is calculated based on at least one of a reduction rate in the number of parameters and a shortening amount in the processing time to be attained in case the number of parameters is reduced for each of an initial neural network and a current neural network before being transformed by the structure transformation process.
